(19) United States
(12) Patent Application Publication
(10) Pub. No.: US 2006/0122914 A1
(43) Pub. Date: Jun. 8, 2006

(54) Method and system of generating catalogs

(76) Inventor: Nathan M. Moroney, Palo Alto, CA (US)

Correspondence Address: HEWLETT-PACKARD COMPANY;Intellectual Property Administration, P.O. Box 272400, Fort Collins, CO, 80527-2400, US

(21) Appl. No.: 10/999,250

(22) Filed: Nov. 30, 2004

(51) Int. Cl. G06F 17/30

(52) U.S. Cl. 705/27

(57) ABSTRACT

A method and system for generating dynamic catalogs representative of the preferences of a customer. In an illustrative implementation, the system comprises a user interface into which a user enters a query indicative of the product or products of interest. The query is processed using an electronic search engine, typically accessible via the internet. The search engine returns the results, which are then compiled to create a catalog. The catalog is then delivered to the user.

### BACKGROUND

Retailers have used catalogs to aid in the selling of products for many years. Items such as the Sears catalog were commonplace in most every household. Over time, many retailers emerged that sold almost exclusively via catalogs, such as Land's End, Spiegels, etc. Catalog sales have long been an effective way to market products for large and small retailers.

Shopping by using printed catalogs delivered to one's home offers many advantages to the customer. The customer can view items, descriptions, and prices from home without having to travel to the store. The customer can browse through the items at his or her leisure, without interference from high pressure salespeople. Additionally, the customer can save time upon arrival should he or she decide to visit the store in person, as he or she already has an idea of the item or items desired from browsing a catalog. In many cases, the trip to the store can be eliminated altogether if the catalog allows for ordering by mail, phone, or on-line. Also, catalog shopping allows the customer to shop at any time of day without regard to store hours.

The retailer can benefit greatly from the use of printed catalogs. Printed catalogs offer an excellent marketing tool that allows retailers to get an audience for their goods from customers who may have otherwise never visited their store. Printed catalogs offer the ability to present a large volume of goods to a perspective customer in a relatively small space conveniently indexed for efficient shopping. Additionally, printed catalogs offer the opportunity to track sales behavior of consumers through the use of coupons included in the catalog, promotional codes, etc.

One drawback with printed catalogs is that the catalog contains a compilation of products determined solely by the retailer who publishes the catalog. In other words, it is the retailer who determines which goods will be included in a catalog. Additionally, most catalogs are retailer specific, meaning that if a customer wishes to see similar items from several stores, he or she must collect separate catalogs from each store.

A consumer who desires to see information on a specific type or category of products may not have the proper catalog handy, and thus is often left to compile the information themselves. Until recently, this typically meant resorting to the Yellow Pages for various vendors and then contacting the vendors individually to determine product and pricing information. More recently, internet searches have been used instead of or in addition to the Yellow Pages. While internet searching has provided an additional means of obtaining current information, the user is still left with the task of visiting each vendor or vendor's web page located by the search to investigate the desired product. Additionally, internet searching typically returns large volumes of information that may be outside of the scope of the product information desired. For example, a user may desire to purchase a kayak. The user could look in a resource such as the Yellow Pages® for sporting equipment suppliers, or he or she could access an internet search engine (e.g., Google®) for information on kayaks. Both options, however, leave the customer with the task of compiling the information found to assist him or her in making a purchasing decision. Following a Yellow Pages® search, the customer must then contact the various sporting goods suppliers listed to determine the types of kayaks that might be available, the cost of each, etc. Additionally, since the Yellow Pages® is only published once a year, some of the information may be outdated. An internet search on the term “kayak” will return more current information, but will also return numerous hits on articles and information about kayaks as well potential kayak vendors, leaving the consumer to sort through the information to locate the product information desired.

A need exists for a system to allow vendors to use catalogs for marketing that overcomes the shortcomings described above. This invention fulfills this need, among others.

### SUMMARY

The present invention provides a system and method for generating dynamic catalogs representative of the preferences of a customer. In an illustrative implementation, the system comprises a user interface into which a user enters a query indicative of the product or products of interest. The query is processed using an electronic search engine, typically accessible via the internet. The search engine returns the results, which are then compiled to create a catalog. The catalog is then delivered to the user.

In one exemplary implementation, the method for generating dynamic catalogs comprises conducting an internet search using a search engine in response to a user inquiry. The results are returned, formatted into catalog form, and delivered to the user via a selected delivery means.

### BRIEF DESCRIPTION OF THE DRAWINGS

For the purpose of illustrating the invention, there is shown in the drawings one exemplary implementation; however, it is understood that this invention is not limited to the precise arrangements and instrumentalities shown.

FIG. 1 is a block diagram illustrating an exemplary system upon which one implementation of the present invention can operate.

FIG. 2 is a flow chart illustrating one embodiment of the steps involved in practicing the present invention.

FIG. 3 is a flow chart illustrating the process shown in FIG. 2 including additional features and capabilities of the invention.

### DETAILED DESCRIPTION

Overview

Current marketing techniques include providing printed catalogs to potential customers. Such catalogs are created by a particular vendor and include information on the vendor's products, such as prices, descriptions, pictures, etc. Such catalogs are distributed to various market segments, normally determined by the vendor by evaluating available sales data. For example, former customers may be placed on a mailing list to receive future catalogs.

Existing techniques, however, do not facilitate sending a product specific catalog to a potential customer who is known to be in the immediate market for such a product. In other words, the catalogs of today are driven by vendors and not by customers. The ability to generate a dynamic catalog supplied to a customer that is specific to his or her needs would benefit both vendors and customers. It would enable the vendor to target the proper market segment (i.e., people who have expressed a direct interest in a particular product) and would enable the customer to quickly and easily evaluate the various products from various retails that satisfy his or her needs.

The system and method in accordance with the present invention provides for dynamic custom catalog generation. The present invention can be utilized to allow for custom catalogs to be delivered to a customer who desires the information contained in the catalog. The catalogs are provided in a format that presents the information in a manner designed to be easily referenced by the consumer and also to allow the retailer to effectively market the products, thus providing improvement over existing internet searching.

Illustrative Computing Environment

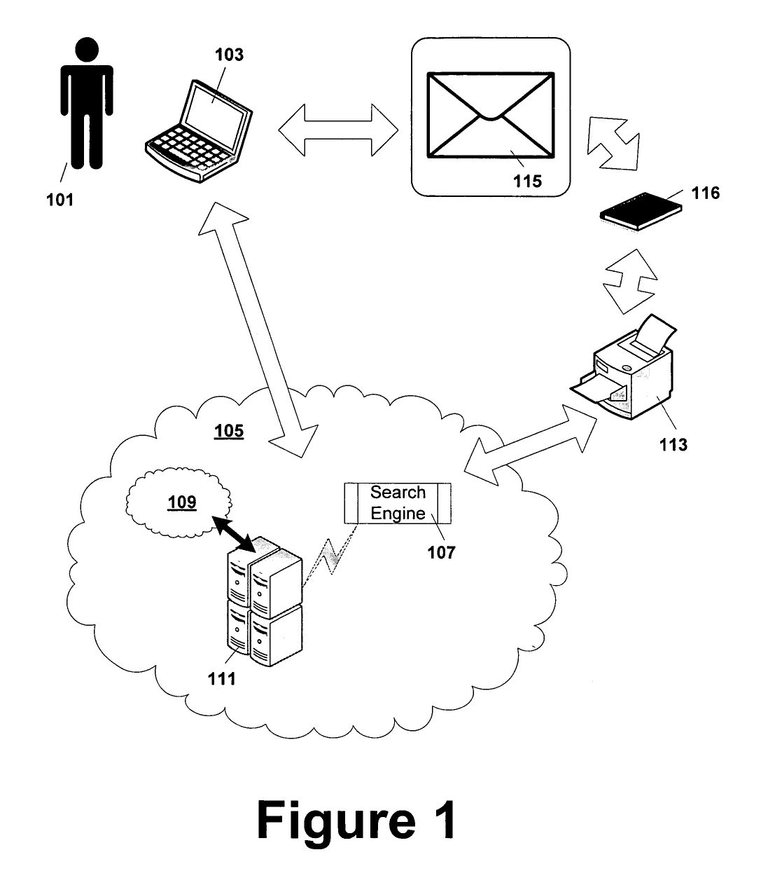

FIG. 1 is a diagram illustrating an exemplary system upon which one implementation of the present invention can operate. The system shown in FIG. 1 includes a perspective customer 101. The perspective customer 101 is someone who is interested in obtaining a custom catalog as provided by the present invention, referred to hereinafter as simply the customer 101. The system includes a user interface 103 to provide the customer 101 with access to the system. Typically, the user interface 103 comprises a computer terminal having access to a network 105, e.g. the internet. Alternative devices having internet access could also provide the user interface 103, such as PDAs, cellular phones, etc. The network 105 provides a means for connection between the user interface 103 and a search engine 107. The search engine can be located on one or more servers 111, or could be hosted remotely. One embodiment of the invention could employ existing search engines (e.g., Google) to perform the search over a wide range of vendors, or alternative embodiments could use a specific custom search engines. For example, a custom search engine could created to search a particular large vendor with a large volume of products who desires to offer the ability to obtain a custom catalog of its various products.

One or more servers 111 are used to host the catalog generation module 109 used to practice the invention. The catalog generation module 109 may comprise software, hardware (e.g., an ASIC), or a combination of both used to compile the results returned from the search engine 107 into catalog format, as more fully described below.

The system may further include a printer 113. The printer can be used to create a printed or hard-copy version of the custom catalog generated by the catalog generation module. The printed catalog 116 can be delivered to the customer 101 via a delivery service 115, such as the U.S. Postal Service or Federal Express.

Dynamic Catalog Creation

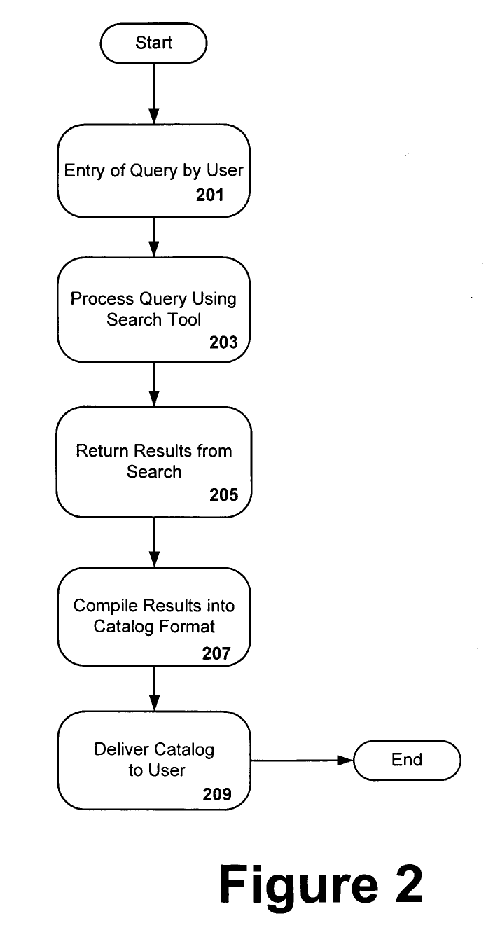

FIG. 2 is a flow chart illustrating one embodiment of the steps involved in practicing the present invention. A customer who desires a custom catalog would access the system via a user interface and enter a query (step 201). For example, a customer who is interested in a particular item would use the system to obtain information specific to the item. An example would be a customer who desires to purchase a kayak. Using the method illustrated in FIG. 2, the consumer defines the information that will appear in the custom catalog by entering the item he desires (e.g., “kayak) into the system as a query via the user interface. In an exemplary embodiment, the user interface provides access to a graphical user interface (GUI) screen, typically displayed as a web page. The GUI screen is thus accessible from any device having internet access.

The query entered by the user is processed via a search engine to return information based on the specific terms of the query (step 203). In an exemplary embodiment, the search engine is designed to search a product entered into the query field and return a listing of vendors, matching products, and prices. In one embodiment, vendors can subscribe to the catalog generating service provider in order to be included in the search engine. In such an event, a preferred format for returning the information can be specified to the vendor by the service provider. For example, a single page document in Adobe .pdf format listing the products that are responsive to the query, prices for each, descriptions, and pictures could be employed. Thus, in response to a query request of “kayaks,” each subscribing kayak vendor would return a .pdf file containing information about their kayaks in accordance with the specified protocol of the provider. While .pdf files are used by way of example, various other formats could also be employed (e.g, HTML pages, .tiff files, jpeg files, etc.). Alternative embodiments would not require subscription or adherence to a predetermined protocol, but would rather employ existing web searching techniques (e.g., metatags embedded in a web page). The results of such a search could be converted into a particular format using programming scripts running on the server of the service provider. These scripts are well known to those of skill in the art. This embodiment, however, may lack the consistency in format that could be created by using a predefined protocol.

The search engine returns the results of the search to the service provider (step 205). The results are then compiled into a catalog format (step 207) in the catalog generation module. In an exemplary implementation, the search results comprise a series of .pdf files, or links to responsive .pdf files, that can be merged into a catalog format. For example, each vendor may return a one page .pdf file (or several pages if the vendor has a large volume of responsive products). The various vender pages can be merged into a single multipage catalog in .pdf format. Existing scripts well known to one of skill in the art can be used to compile, format, and index the results into a single .pdf file representative of a custom catalog.

The completed custom catalog is then delivered to the customer (step 209). One embodiment would allow the customer to download the catalog electronically as a .pdf file, which could then be printed locally by the customer. Alternative embodiments, more fully described below, provide for high quality printing of the custom catalog and delivery via U.S. Mail, or overnight carrier should delivery time be of concern.

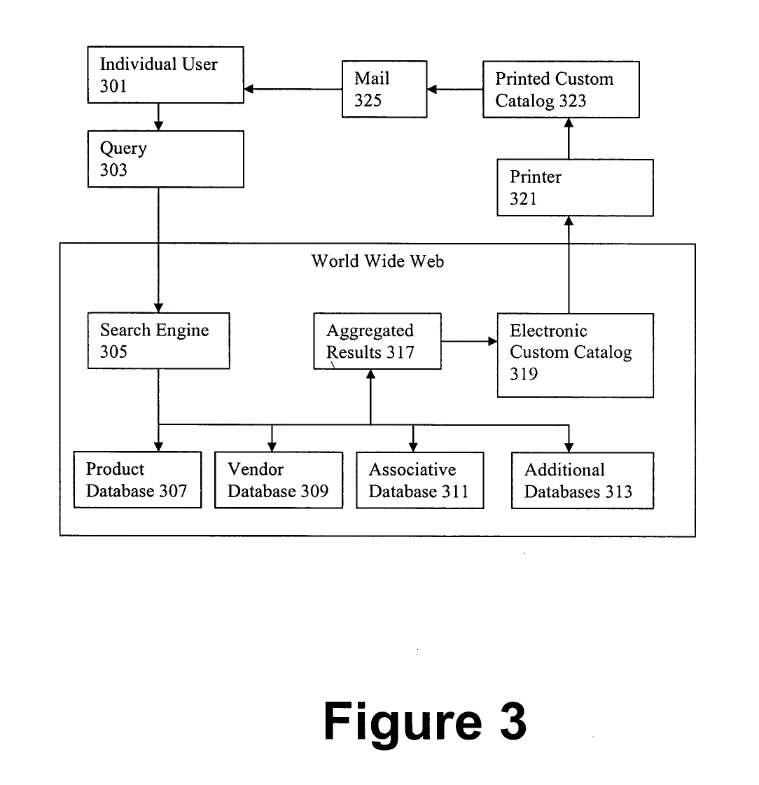

FIG. 3 is a block diagram showing another exemplary embodiment of the invention. A user 301 enters a query 303 into the system. The query is processed by a search engine 305. The search engine 305 may comprise a computerized database with some form of user interface that allows individuals to query the database according specific keywords, topical areas, logical conditions or other options. For example, the search engine 305 could consist of a simple text box in which users can type a keyword. After the computer system has searched a database, a window can be provided with a prioritized listing of documents, images, URL's or other items stored in the database. An example of this type of search engine would be the Yahoo search engine on the World Wide Web (http://search.yahoo.com/). An alternative search engine might be structured around a cell phone in which the user enters a query using the keypad on the phone or provides a spoken keyword in combination with voice recognition techniques. The query is forwarded to a computer system with a database, which searches the database (or databases) and returns a prioritized listing of the results. An example of this type of search engine would be wireless Google (http://www.google.com/options/wireless.html). Other types of search engines having a computer system with a database stored in a memory and some form of user interface could also be used, such as a search engine that may be limited to a given domain or intranet (e.g., http://search.hp.com/).

In one embodiment, the search engine 305 conducts the search process in one or more databases, depending upon the terms of the query. Information supplied by participating vendors is indexed into various databases. A product database 307 is used to return information regarding the specific item specified in the query. For example, a request for “printers” could be searched in the product database to return results of all products matching the search criteria, and may include price information for each respective product. Or, the user could specify a particular brand of interest, such as “HP printers.” In this case, a vendor database 309 could be used to search products and pricing of a specific vendor. Additionally, in one embodiment, the system could allow for the inclusion in the end catalog of associative products. For example, a user requesting a search on printers may be provided information in the catalog regarding printer supplies (e.g., ink, toner, paper, etc.). An associative database 311 can be used to match related products to the product that is the subject of the query. The results can then be included in the catalog generated. The databases described herein are only by way of example, and other additional search databases 313 could be created depending on the application.

The decision as to which databases to search can be user defined (e.g., a user could choose if he or she would like to have related products included in the catalog), or the system provider could determine which databases are to be included in the search. For example, the system could be employed by a single large organization that offers many products. For example, the ability to generate a custom catalog of a company's products could be included on the company's web site. In such an event, the organization is only interested in searching within its internal product line, thus the database would not contain any products of other vendors. Other embodiments include a system unaffiliated with any specific vendor. The customer would access the system directly through the service provider's own site. In this embodiment, many products of many vendors could be included in a product database.

Once the searching is complete, the results from searching the various database are compiled to form a set of aggregated results 317. The aggregated results are formatted to form an electronic custom catalog 319. As discussed previously, in one embodiment the formatting creates the electronic catalog 319 in .PDF format, although various alternative formats could also be used.

The electronic catalog is sent to a high quality printer 321 to create a custom printed catalog 323. One embodiment would allow for the custom electronic catalog 319 to be delivered electronically to the user 301, however, there are advantages to delivering a hard copy printed catalog 323. For example, if the delivery method is via U.S. Mail 325, the user 301 would be required to enter his or her mailing address. This would allow for better demographical tracking of the demand for a particular product. Such data could be tracked by a specific vendor, or, alternatively, product specific data could be tracked by the service provider for many vendors. This would create an additional resource which is of value. Delivery of the printed catalog 323 via U.S. Mail 325 or other courier would also better enable vendors in vendor specific systems to keep catalogs of all of their products from being sent to competitors. It is less feasible to monitor the delivery location of an electronic document. For these and other reasons, some embodiments of the system would only allow for delivery of the printed catalog 323.

A variety of modifications to the embodiments described will be apparent to those skilled in the art from the disclosure provided herein. For example, systems can be employed that require the user to register before having access to custom catalogs, thus allowing collection of additional demographical and lifestyle information that could be valuable from a sales and marketing standpoint. Promotional items and coupons could be incorporated into the custom catalogs. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A method for generating catalogs comprising:
inputting a query by a user into a user interface;
conducting a search based on said query using a search engine;
compiling results of the search into a catalog; and
delivering the catalog to the user.

2. The method as set forth in claim 1 wherein the catalog is in electronic format.

3. The method of claim 2, wherein the electronic format is .PDF format.

4. The method as set forth in claim 1 further comprising printing the catalog before delivery.

5. The method as set forth in claim 4 wherein the catalog is delivered to the user via postal mail.

6. The method as set forth in claim 1 wherein the catalog comprises a list of products and a price of each.

7. The method as set forth in claim 1 wherein the search is conducted using an internet search engine.

8. The method as set forth in claim 1 wherein the user interface comprises a GUI screen.

9. The method as set forth in claim 1 wherein the search is conducted in a predetermined database of vendors.

10. The method as set forth in claim 9 further comprising subscribing by the vendors to a service provider to be included in the vendor database.

11. The method as set forth in claim 1 wherein the catalog includes vendor coupons.

12. A system for generating catalogs comprising:
a user interface for accepting a query from a user;
a search engine for searching one or more databases in response to said query and returning search results; and
a catalog generation module for compiling search results returned by said search engine into an electronic catalog.

13. The system as set forth in claim 12, further comprising:
a printer for printing said electronic catalog to obtain a printed catalog.

14. The system as set forth in claim 13, wherein the printed catalog is delivered to the user via postal mail.

15. The system as set forth in claim 12 wherein said electronic catalog is in .PDF format.

16. The system as set forth in claim 12 wherein said one or more databases includes a vendor database.

17. The system as set forth in claim 12 wherein said one or more database includes a product database.

18. A system for generating catalogs comprising:
means for a user to enter a query;
means for conducting a search in one or more databases in response to said query and returning search results; and
means for generating a catalog from said search results.

19. A computer program product comprising a computer useable medium having program logic stored thereon, wherein said program logic comprises machine readable code executable by a computer in communication with a network, wherein said machine readable code comprises instructions for:
conducting a search using a search engine in response to a query provided by a user;
compiling the results of the search into a catalog; and
delivering the catalog to the user.

20. The computer program product as set forth in claim 19, wherein the catalog is in electronic format.

21. The computer program product as set forth in claim 20, wherein the electronic format is .PDF format.

22. The computer program product as set forth in claim 19 further comprising instructions for printing the catalog before delivery.
